(19) United States
(12) Patent Application Publication
(10) Pub. No.: US 2010/0010650 A1
(43) Pub. Date: Jan. 14, 2010

(54) Method and apparatus for processing digital audio signal

(75) Inventor: Naoya Ooue, Gunma-ken (JP)

Correspondence Address: LOUIS WOO;LAW OFFICE OF LOUIS WOO, 717 NORTH FAYETTE STREET, ALEXANDRIA, VA, 22314, US

(73) Assignee: Victor Company of Japan, Ltd., Yokohama (JP)

(21) Appl. No.: 12/453,207

(22) Filed: May 1, 2009

(30) Foreign Application Priority Data
Jul. 11, 2008 (JP) 2008-180900

(51) Int. Cl. G06F 17/00

(52) U.S. Cl. 700/94

(57) ABSTRACT

There is a sequence of samples having values representative of a waveform. Peak-corresponding samples are detected which correspond to respective peaks including local maximums and local minimums in the waveform. An ideal waveform peak is estimated from the value of each detected peak-corresponding sample and values of samples temporally adjacent to the detected peak-corresponding sample through interpolation. A time interval between every two temporally adjacent estimated peaks is calculated. One is selected from coefficients in accordance with the calculated time interval. The value of each detected peak-corresponding sample and values of samples temporally adjacent to the detected peak-corresponding sample are corrected in response to the selected coefficient, the value of an estimated peak corresponding to the detected peak-corresponding sample, and a time position of the estimated peak.

### BACKGROUND OF THE INVENTION

1. Field of the Invention

This invention relates to a method and an apparatus for processing a digital audio signal to enhance the quality of audio contents represented by the digital audio signal.

2. Description of the Related Art

Typical conversion of an analog audio signal to a digital audio signal has a step of periodically sampling the analog audio signal at a prescribed sampling frequency to generate analog samples, and a step of changing the analog samples into corresponding digital samples constituting the digital audio signal. According to the Nyquist Theorem, the frequency of audio contents represented by the digital audio signal is limited to lower than the Nyquist frequency equal to a half of the sampling frequency.

The CD (compact disc) standards prescribe that a digital audio signal which results from analog-to-digital conversion of an analog audio signal at a sampling frequency of 44.1 kHz and a quantization bit number of 16 should be recorded on a CD. Therefore, the frequency of audio contents represented by the digital audio signal recorded on the CD is limited to lower than 22.05 kHz (the Nyquist frequency). Accordingly, components of the analog audio signal which have frequencies of 22.05 kHz or higher are lost during the analog-to-digital conversion to generate the digital audio signal. In general, such high-frequency components cause good presence or reality when audio contents represented by the analog audio signal are reproduced. Since the digital audio signal lacks high-frequency-corresponding components, audio contents reproduced from the digital audio signal tend to be poor in presence or reality.

U.S. Pat. No. 7,024,260 corresponding to Japanese Patent No. 3659489 discloses a method and an apparatus for shaping the waveform represented by a digital audio signal to compensate for lost high-frequency-corresponding components. In the method and the apparatus of U.S. Pat. No. 7,024,260, maximal and minimal values represented by samples of a digital audio signal are detected. A number of samples from a sample representing a minimal value to a maximum-value-corresponding sample is detected. A number of samples from a sample representing a maximal value to a minimal-value-corresponding sample is detected. Calculation is given of a first difference between the maximal-value-corresponding sample and the immediately-preceding sample. Calculation is given of a second difference between the minimal-value-corresponding sample and the immediately-preceding sample. First and second coefficients are calculated from the detected sample numbers. The first coefficient and the first difference are multiplied to generate a first multiplication result. The second coefficient and the second difference are multiplied to generate a second multiplication result. The maximal value represented by the maximal-value-corresponding sample is incremented by the first multiplication result. The minimal value represented by the minimal-value-corresponding sample is decremented by the second multiplication result.

In general, the waveform represented by a digital audio signal, which results from analog-to-digital conversion of an analog audio signal at a prescribed sampling frequency, slightly differs from that represented by the analog audio signal. For example, the time positions and values of most local maximums and minimums in the waveform represented by the digital audio signal slightly differ from those of corresponding local maximums and minimums in the waveform represented by the analog audio signal. The above signal processing in the method and the apparatus of U.S. Pat. No. 7,024,260 can not sufficiently compensate for such differences in time position and value between local maximums and minimums in the waveform represented by the digital audio signal and those in the waveform represented by the analog audio signal since the time-position differences are not considered.

Japanese patent application publication number 06-181459 discloses subjecting a sequence of digital samples representing a waveform to linear interpolation to generate new digital samples temporally located between the original digital samples. A resultant sequence of the original digital samples and the new digital samples represents a waveform smoother than that represented by the original digital samples. In Japanese application 06-181459, a first basic value ωα1 of a new sample in a time position between two successive original samples Pn and Pn+1 is calculated as follows.

ωα1=ωn+(ωn+1−ωn)·f

where “ωn” and “ωn+1” denote the values of the original samples Pn and Pn+1 respectively, and “f” denotes a parameter indicative of the time position of the new sample. Then, a second basic value ωα2 of the new sample is calculated as follows.

ωα2=ωn+(ωn−ωn−1)·f

where “ωn−1” denotes the value of an original sample Pn−1 immediately preceding the original sample Pn. A final value ωout of the new sample is calculated from the first and second basic values ωα1 and ωα2 as follows.

ωout=ωα2+(ωα1−ωα2)·f

In Japanese application 06-181459, the original samples remain unchanged although the new samples are added.

Japanese patent application publication number 62-221212 discloses a digital signal processor designed to obtain a non-clipped smoothed waveform to improve the tone quality of audio contents. In the processor of Japanese application 62-221212, a peak detector receives a sequence of words and detects every word taking a peak value. The peak detector informs a counter of every detected word taking the peak value. The counter detects the number of successive words taking the peak value, that is, the duration for which a related waveform continues to be clipped. Data of words immediately preceding and following a set of successive words taking the peak value are stored in a memory. A calculating circuit computes an estimated non-clipped peak value and a time position thereof from the word number detected by the counter and the values of the word data in the memory. A ROM stores prescribed peak waveform functions. The estimated-peak time position computed by the calculating circuit is used as an address for the ROM. Accordingly, one is selected from the peak waveform functions in accordance with the estimated-peak time position. The calculating circuit adds a prescribed coefficient to the selected peak waveform function to generate an interpolation function. Information representing the generated interpolation function is added to the sequence of words to correct the clipped portion of the original waveform into a non-clipped shape. In the processor of Japanese application 62-221212, a non-clipped portion of the original waveform remains uncorrected.

### SUMMARY OF THE INVENTION

It is a first object of this invention to provide a method of processing a digital audio signal to effectively enhance the quality of audio contents represented by the digital audio signal.

It is a second object of this invention to provide an apparatus for processing a digital audio signal to effectively enhance the quality of audio contents represented by the digital audio signal.

A first aspect of this invention provides a method of processing a digital audio signal having a sequence of samples having values representative of a waveform. The method comprises the steps of comparing values of temporally adjacent samples to detect peak-corresponding samples which correspond to respective peaks including local maximums and local minimums in the waveform; estimating an ideal waveform peak from the value of each detected peak-corresponding sample and values of samples temporally adjacent to said detected peak-corresponding sample through interpolation; calculating a time interval between every two temporally adjacent estimated peaks; selecting one from coefficients in accordance with the calculated time interval; and correcting the value of each detected peak-corresponding sample and values of samples temporally adjacent to said detected peak-corresponding sample in response to the selected coefficient, the value of an estimated peak corresponding to said detected peak-corresponding sample, and a time position of said estimated peak.

A second aspect of this invention is based on the first aspect thereof, and provides a method wherein the detected peak-corresponding samples are detected maximum-corresponding samples and detected minimum-corresponding samples, and the estimated peaks are estimated maximums and estimated minimums, and wherein the correcting step comprises making a first sample group having each detected maximum-corresponding sample and a prescribed number of samples temporally adjacent to said detected maximum-corresponding sample; for each sample in the first sample group, calculating a first difference in value between said sample and a next sample or an estimated maximum corresponding to the first sample group, and multiplying the calculated first difference by the selected coefficient to obtain a first corrective value; making a second sample group having each detected minimum-corresponding sample and a prescribed number of samples temporally adjacent to said detected minimum-corresponding sample; for each sample in the second sample group, calculating a second difference in value between said sample and a next sample or an estimated minimum corresponding to the second sample group, and multiplying the calculated second difference by the selected coefficient to obtain a second corrective value; changing the value of each sample in the first sample group in response to the first corrective value; and changing the value of each sample in the second sample group in response to the second corrective value.

A third aspect of this invention is based on the second aspect thereof, and provides a method wherein for a time interval from each estimated maximum to a next estimated minimum, the correcting step comprises calculating a difference in value between said estimated maximum and a post-estimated-maximum sample immediately following said estimated maximum and being in the first sample group; measuring a time interval between said estimated maximum and said post-estimated-maximum sample; multiplying said calculated difference, said measured time interval, and the selected coefficient to obtain a multiplication result; labeling said obtained multiplication result as the first corrective value for said post-estimated-maximum sample; calculating a difference in value between each of the samples in the first sample group except the post-estimated-maximum sample and a sample immediately preceding said each of the samples; multiplying said calculated difference by the selected coefficient to obtain a multiplication result; labeling said obtained multiplication result as the first corrective value for said each of the samples; calculating a difference in value between said estimated minimum and a pre-estimated-minimum sample immediately preceding said estimated minimum and being in the second sample group; measuring a time interval between said estimated minimum and said pre-estimated-minimum sample; multiplying said calculated difference, said measured time interval, and the selected coefficient to obtain a multiplication result; labeling said obtained multiplication result as the second corrective value for said pre-estimated-minimum sample; calculating a difference in value between each of the samples in the second sample group except the pre-estimated-minimum sample and a sample immediately following said each of the samples; multiplying said calculated difference by the selected coefficient to obtain a multiplication result; and labeling said obtained multiplication result as the second corrective value for said each of the samples; and wherein for a time interval from each estimated minimum to a next estimated maximum, the correcting step comprises calculating a difference in value between said estimated maximum and a pre-estimated-maximum sample immediately preceding said estimated maximum and being in the first sample group; measuring a time interval between said estimated maximum and said pre-estimated-maximum sample; multiplying said calculated difference, said measured time interval, and the selected coefficient to obtain a multiplication result; labeling said obtained multiplication result as the first corrective value for said pre-estimated-maximum sample; calculating a difference in value between each of the samples in the first sample group except the pre-estimated-maximum sample and a sample immediately following said each of the samples; multiplying said calculated difference by the selected coefficient to obtain a multiplication result; labeling said obtained multiplication result as the first corrective value for said each of the samples; calculating a difference in value between said estimated minimum and a post-estimated-minimum sample immediately following said estimated minimum and being in the second sample group; measuring a time interval between said estimated minimum and said post-estimated-minimum sample; multiplying said calculated difference, said measured time interval, and the selected coefficient to obtain a multiplication result; labeling said obtained multiplication result as the second corrective value for said post-estimated-minimum sample; calculating a difference in value between each of the samples in the second sample group except the post-estimated-minimum sample and a sample immediately preceding said each of the samples; multiplying said calculated difference by the selected coefficient to obtain a multiplication result; and labeling said obtained multiplication result as the second corrective value for said each of the samples.

A fourth aspect of this invention provides an apparatus for processing a digital audio signal having a sequence of samples having values representative of a waveform. The apparatus comprises means for comparing values of temporally adjacent samples to detect peak-corresponding samples which correspond to respective peaks including local maximums and local minimums in the waveform; means for estimating an ideal waveform peak from the value of each detected peak-corresponding sample and values of samples temporally adjacent to said detected peak-corresponding sample through interpolation; means for calculating a time interval between every two temporally adjacent estimated peaks; means for selecting one from coefficients in accordance with the calculated time interval; and means for correcting the value of each detected peak-corresponding sample and values of samples temporally adjacent to said detected peak-corresponding sample in response to the selected coefficient, the value of an estimated peak corresponding to said detected peak-corresponding sample, and a time position of said estimated peak.

A fifth aspect of this invention is based on the fourth aspect thereof, and provides an apparatus wherein the detected peak-corresponding samples are detected maximum-corresponding samples and detected minimum-corresponding samples, and the estimated peaks are estimated maximums and estimated minimums, and wherein the correcting means comprises means for making a first sample group having each detected maximum-corresponding sample and a prescribed number of samples temporally adjacent to said detected maximum-corresponding sample; means for, for each sample in the first sample group, calculating a first difference in value between said sample and a next sample or an estimated maximum corresponding to the first sample group, and multiplying the calculated first difference by the selected coefficient to obtain a first corrective value; means for making a second sample group having each detected minimum-corresponding sample and a prescribed number of samples temporally adjacent to said detected minimum-corresponding sample; means for, for each sample in the second sample group, calculating a second difference in value between said sample and a next sample or an estimated minimum corresponding to the second sample group, and multiplying the calculated second difference by the selected coefficient to obtain a second corrective value; means for changing the value of each sample in the first sample group in response to the first corrective value; and means for changing the value of each sample in the second sample group in response to the second corrective value.

A sixth aspect of this invention is based on the fifth aspect thereof, and provides an apparatus wherein for a time interval from each estimated maximum to a next estimated minimum, the correcting means comprises means for calculating a difference in value between said estimated maximum and a post-estimated-maximum sample immediately following said estimated maximum and being in the first sample group; means for measuring a time interval between said estimated maximum and said post-estimated-maximum sample; means for multiplying said calculated difference, said measured time interval, and the selected coefficient to obtain a multiplication result; means for labeling said obtained multiplication result as the first corrective value for said post-estimated-maximum sample; means for calculating a difference in value between each of the samples in the first sample group except the post-estimated-maximum sample and a sample immediately preceding said each of the samples; means for multiplying said calculated difference by the selected coefficient to obtain a multiplication result; means for labeling said obtained multiplication result as the first corrective value for said each of the samples; means for calculating a difference in value between said estimated minimum and a pre-estimated-minimum sample immediately preceding said estimated minimum and being in the second sample group; means for measuring a time interval between said estimated minimum and said pre-estimated-minimum sample; means for multiplying said calculated difference, said measured time interval, and the selected coefficient to obtain a multiplication result; means for labeling said obtained multiplication result as the second corrective value for said pre-estimated-minimum sample; means for calculating a difference in value between each of the samples in the second sample group except the pre-estimated-minimum sample and a sample immediately following said each of the samples; means for multiplying said calculated difference by the selected coefficient to obtain a multiplication result; and means for labeling said obtained multiplication result as the second corrective value for said each of the samples; and wherein for a time interval from each estimated minimum to a next estimated maximum, the correcting means comprises means for calculating a difference in value between said estimated maximum and a pre-estimated-maximum sample immediately preceding said estimated maximum and being in the first sample group; means for measuring a time interval between said estimated maximum and said pre-estimated-maximum sample; means for multiplying said calculated difference, said measured time interval, and the selected coefficient to obtain a multiplication result; means for labeling said obtained multiplication result as the first corrective value for said pre-estimated-maximum sample; means for calculating a difference in value between each of the samples in the first sample group except the pre-estimated-maximum sample and a sample immediately following said each of the samples; means for multiplying said calculated difference by the selected coefficient to obtain a multiplication result; means for labeling said obtained multiplication result as the first corrective value for said each of the samples; means for calculating a difference in value between said estimated minimum and a post-estimated-minimum sample immediately following said estimated minimum and being in the second sample group; means for measuring a time interval between said estimated minimum and said post-estimated-minimum sample; means for multiplying said calculated difference, said measured time interval, and the selected coefficient to obtain a multiplication result; means for labeling said obtained multiplication result as the second corrective value for said post-estimated-minimum sample; means for calculating a difference in value between each of the samples in the second sample group except the post-estimated-minimum sample and a sample immediately preceding said each of the samples; means for multiplying said calculated difference by the selected coefficient to obtain a multiplication result; and means for labeling said obtained multiplication result as the second corrective value for said each of the samples.

This invention shapes the waveform represented by the input digital audio signal, and provides the following advantage. The effect of the waveform shaping on the input digital audio signal is more uniform than that of a waveform shaping process responsive to a peak-corresponding sample only.

### BRIEF DESCRIPTION OF THE DRAWINGS

FIG. 1 is a block diagram of a digital audio signal processing apparatus according to a first embodiment of this invention.

FIG. 2 is a time-domain diagram showing a waveform of an original analog audio signal, and samples of a digital audio signal generated by analog-to-digital conversion of the original analog audio signal.

FIG. 3 is an enlarged view of a portion of FIG. 2.

FIG. 4 is a time-domain diagram showing an example of a portion of an original analog waveform and samples of an input digital audio signal.

FIG. 5 is a time-domain diagram showing an example of a portion of an original analog waveform, samples of an input digital audio signal, samples of an output digital audio signal, and a corrected analog waveform represented by the output digital audio signal.

FIG. 6 is a block diagram of a digital audio signal processing apparatus according to a second embodiment of this invention.

FIG. 7 is a flowchart of a computer program for the apparatus in FIG. 6.

### DETAILED DESCRIPTION OF THE INVENTION

### First Embodiment

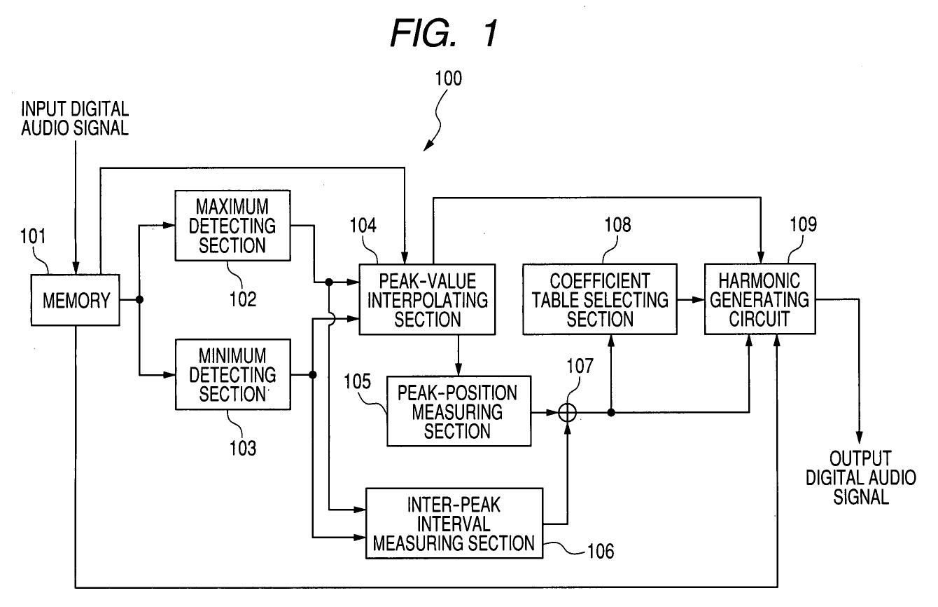

FIG. 1 shows a digital audio signal processing apparatus 100 according to a first embodiment of this invention. The apparatus 100 includes a memory (a buffer) 101, a maximum detecting section 102, a minimum detecting section 103, a peak-value interpolating section 104, a peak-position measuring section 105, an inter-peak interval measuring section 106, an adder 107, a coefficient table selecting section 108, and a harmonic generating circuit 109.

The memory 101 receives an input digital audio signal formed by a sequence of samples having values representing a waveform of an original analog audio signal from which the input digital audio signal is generated through analog-to-digital conversion at a prescribed sampling frequency. Each of the samples has a predetermined number of bits. The samples are spaced at intervals equal to the prescribed sampling period (the reciprocal of the sampling frequency). The memory 101 stores a predetermined number of latest samples of the input digital audio signal. Each time the newest sample is stored into the memory 101, the oldest sample is erased therefrom. The input digital audio signal propagates from the memory 101 to the harmonic generating circuit 109. Accordingly, the harmonic generating circuit 109 receives samples of the input digital audio signal.

The maximum detecting section 102 and the minimum detecting section 103 read samples of the input digital audio signal from the memory 101, and check the read samples to detect peaks (extrema) consisting of local maximums and minimums in the waveform represented by the input digital audio signal. Specifically, the maximum detecting section 102 detects every local maximum in the waveform represented by the input digital audio signal, and a sample corresponding to the detected local maximum. The minimum detecting section 103 detects every local minimum in the waveform represented by the input digital audio signal, and a sample corresponding to the detected local minimum. The maximum detecting section 102 and the minimum detecting section 103 notify the peak-value interpolating section 104 and the inter-peak interval measuring section 106 of every detected local maximum, a sample corresponding to the detected local maximum, every detected local minimum, and a sample corresponding to the detected local minimum (that is, every detected peak and a sample corresponding to the detected peak).

In more detail, the maximum detecting section 102 performs the following operation steps on a sample-by-sample basis. The maximum detecting section 102 subtracts the value of a second immediately preceding sample with respect to the current sample from the value of a first immediately preceding sample with respect to the current sample to get a first subtraction result. The maximum detecting section 102 subtracts the value of the first immediately preceding sample from the value of the current sample to get a second subtraction result. The maximum detecting section 102 decides whether or not the first subtraction result is positive and the second subtraction result is negative. When it is decided that the first subtraction result is positive and the second subtraction result is negative, the maximum detecting section 102 labels the value of the first immediately preceding sample as a local maximum (a peak) and recognizes the first immediately preceding sample as a sample corresponding to the local maximum. In this way, the maximum detecting section 102 compares the values of the current sample and the first and second immediately preceding samples with respect to the current sample to implement the detection of a maximum-corresponding sample (a peak-corresponding sample).

The minimum detecting section 103 performs the following operation steps on a sample-by-sample basis. The minimum detecting section 103 subtracts the value of the second immediately preceding sample with respect to the current sample from the value of the first immediately preceding sample with respect to the current sample to get a first subtraction result. The minimum detecting section 103 subtracts the value of the first immediately preceding sample from the value of the current sample to get a second subtraction result. The minimum detecting section 103 decides whether or not the first subtraction result is negative and the second subtraction result is positive. When it is decided that the first subtraction result is negative and the second subtraction result is positive, the minimum detecting section 103 labels the value of the first immediately preceding sample as a local minimum (a peak) and recognizes the first immediately preceding sample as a sample corresponding to the local minimum. In this way, the minimum detecting section 103 compares the values of the current sample and the first and second immediately preceding samples with respect to the current sample to implement the detection of a minimum-corresponding sample (a peak-corresponding sample).

For every peak-corresponding sample (every maximum-corresponding or minimum-corresponding sample) notified by the maximum detecting section 102 or the minimum detecting section 103, the peak-value interpolating section 104 reads a pre-peak sample and a post-peak sample (samples immediately preceding and immediately following the peak-corresponding sample) from the memory 101. The peak-value interpolating section 104 decides whether the values of the read pre-peak and post-peak samples are different or equal. When these values are different, the peak-value interpolating section 104 estimates an ideal analog-waveform peak (an ideal analog-waveform local maximum or minimum) through interpolation responsive to the values of samples including at least the peak-corresponding sample, the pre-peak sample, and the post-peak sample. The peak-value interpolating section 104 notifies the estimated peak to the peak-position measuring section 105 and the harmonic generating circuit 109. The estimated peak is used instead of the present peak detected by the maximum detecting section 102 or the minimum detecting section 103. On the other hand, when the values of the pre-peak and post-peak samples are equal, the peak-value interpolating section 104 does not perform interpolation and concludes the present peak detected by the maximum detecting section 102 or the minimum detecting section 103 to be correct and coincident with an ideal analog-waveform peak. In this case, the present peak detected by the maximum detecting section 102 or the minimum detecting section 103 is used.

Preferably, the interpolation implemented by the peak-value interpolating section 104 is of a Lagrange-polynomial type designed as follows. When the values of the pre-peak and post-peak samples are different, the peak-value interpolating section 104 further reads a second pre-peak sample and a second post-peak sample (samples second-immediately preceding and second-immediately following the peak-corresponding sample) from the memory 101. Then, the peak-value interpolating section 104 estimates an ideal analog-waveform peak from the values of the peak-corresponding sample, the pre-peak and post-peak samples, and the second pre-peak and post-peak samples according to a Lagrange polynomial.

Peak-corresponding samples detected by the maximum detecting section 102 and the minimum detecting section 103 are sent to the peak-position measuring section 105 via the peak-value interpolating section 104. The peak-position measuring section 105 determines the time position of every estimated peak relative to the time position of a related peak-corresponding sample. Specifically, the peak-position measuring section 105 determines the temporal distance (the interval) between the time position of the estimated peak and the time position of the related peak-corresponding sample. The determined temporal distance is shorter than the sampling period decided by the sampling frequency. The peak-position measuring section 105 feeds information representative of the determined relative time position of the estimated peak to the adder 107 as estimated-peak positional information.

The inter-peak interval measuring section 106 responds to maximum-corresponding samples and minimum-corresponding samples (peak-corresponding samples) notified by the maximum detecting section 102 and the minimum detecting section 103. The inter-peak interval measuring section 106 measures the time interval between every peak-corresponding sample and the next peak-corresponding sample (the time interval between every maximum-corresponding sample and an immediately-following minimum-corresponding sample or the time interval between every minimum-corresponding sample and an immediately-following maximum-corresponding sample). The measured time interval is referred to as the inter-peak-sample interval. The inter-peak interval measuring section 106 feeds information representative of the inter-peak-sample interval to the adder 107. The measurement of the inter-peak-sample interval is implemented by, for example, counting pulses of a sample clock signal synchronized with the input digital audio signal during each of time intervals between the moments of detection of peak-corresponding samples. The sample clock signal is generated by a conventional device.

The adder 107 adds the estimated-peak positional information fed from the peak-position measuring section 105 and the inter-peak-sample interval information fed from the inter-peak interval measuring section 106 to obtain addition-result information representing every inter-estimated-peak interval, that is, the time interval between every two temporally adjacent estimated peaks. The adder 107 feeds the addition-result information to the coefficient table selecting section 108. In addition, the adder 107 passes the estimated-peak positional information to the harmonic generating circuit 109.

The coefficient table selecting section 108 includes a memory storing data representing a table of coefficients assigned to different inter-estimated-peak intervals. The coefficient table selecting section 108 selects, from the coefficients in the table, one assigned to an inter-estimated peak interval equal to that represented by the addition-result information fed from the adder 107. The coefficient table selecting section 108 notifies the selected coefficient to the harmonic generating circuit 109.

Information about every maximum-corresponding sample detected by the maximum detecting section 102 and information about every minimum-corresponding sample detected by the minimum detecting section 103 are sent to the harmonic generating circuit 109 through the inter-peak interval measuring section 106 and the adder 107 or the peak-value interpolating section 104. Among the samples coming from the memory 101 (the samples of the input digital audio signal), the harmonic generating circuit 109 identifies every maximum-corresponding sample, a sample immediately preceding the maximum-corresponding sample, and a sample immediately following the maximum-corresponding sample. The harmonic generating circuit 109 calculates corrective values for the maximum-corresponding sample, the immediately-preceding sample, and the immediately-following sample from the estimated peak notified by the peak-value interpolating section 104, the estimated-peak positional information fed via the adder 107, and the selected coefficient notified by the coefficient table selecting section 108. The harmonic generating circuit 109 implements this calculation according to prescribed equations. The harmonic generating circuit 109 adds or subtracts the calculated corrective values to or from the original values of the maximum-corresponding sample, the immediately-preceding sample, and the immediately-following sample. The harmonic generating circuit 109 replaces the original values of these samples with the addition or subtraction results. Thus, the harmonic generating circuit 109 changes these original sample values into the corrected sample values, and obtains the corrected samples.

Among the samples coming from the memory 101 (the samples of the input digital audio signal), the harmonic generating circuit 109 identifies every minimum-corresponding sample, a sample immediately preceding the minimum-corresponding sample, and a sample immediately following the minimum-corresponding sample. The harmonic generating circuit 109 calculates corrective values for the minimum-corresponding sample, the immediately-preceding sample, and the immediately-following sample from the estimated peak notified by the peak-value interpolating section 104, the estimated-peak positional information fed via the adder 107, and the selected coefficient notified by the coefficient table selecting section 108. The harmonic generating circuit 109 implements this calculation according to prescribed equations. The harmonic generating circuit 109 adds or subtracts the calculated corrective values to or from the original values of the minimum-corresponding sample, the immediately-preceding sample, and the immediately-following sample. The harmonic generating circuit 109 replaces the original values of these samples with the addition or subtraction results. Thus, the harmonic generating circuit 109 changes these original sample values into the corrected sample values, and obtains the corrected samples.

The harmonic generating circuit 109 does not change the other samples coming from the memory 101. Accordingly, these samples are non-corrected samples. The harmonic generating circuit 109 outputs the corrected samples and the non-corrected samples as an output digital audio signal. The harmonic generating circuit 109 feeds the output digital audio signal to an apparatus output terminal or an external device (not shown). The correction of the previously-mentioned specified ones among the samples of the input digital audio signal by the harmonic generating circuit 109 produces a digital signal representative of harmonics, and adds the digital harmonic signal to the input digital audio signal to generate the output digital audio signal.

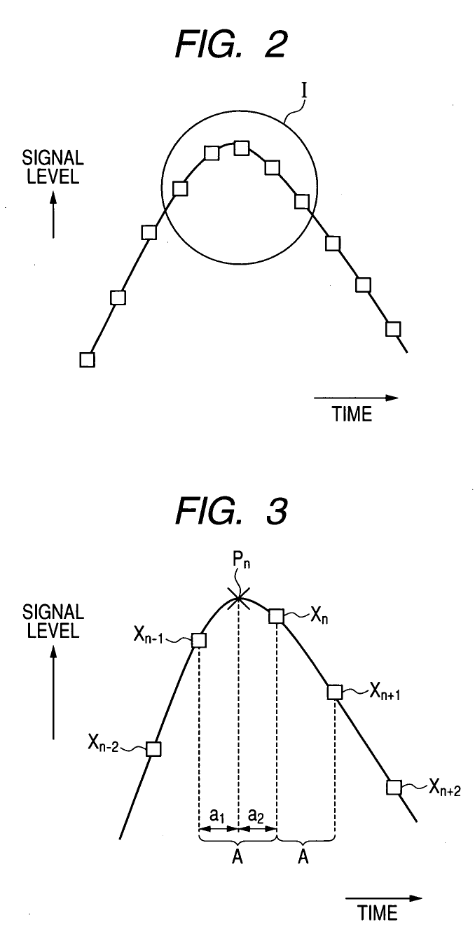

With reference to FIG. 2, the solid line denotes an example of a partial waveform of an original analog audio signal. The original analog audio signal is periodically sampled at a prescribed sampling frequency to generate an analog sample. Every analog sample is converted into a digital sample. The resultant digital samples are in a sequence forming the input digital audio signal. Samples of the input digital audio signal are spaced at time intervals equal to the sampling period. In FIG. 2, the small squares denote the time positions and the values of samples of the input digital audio signal.

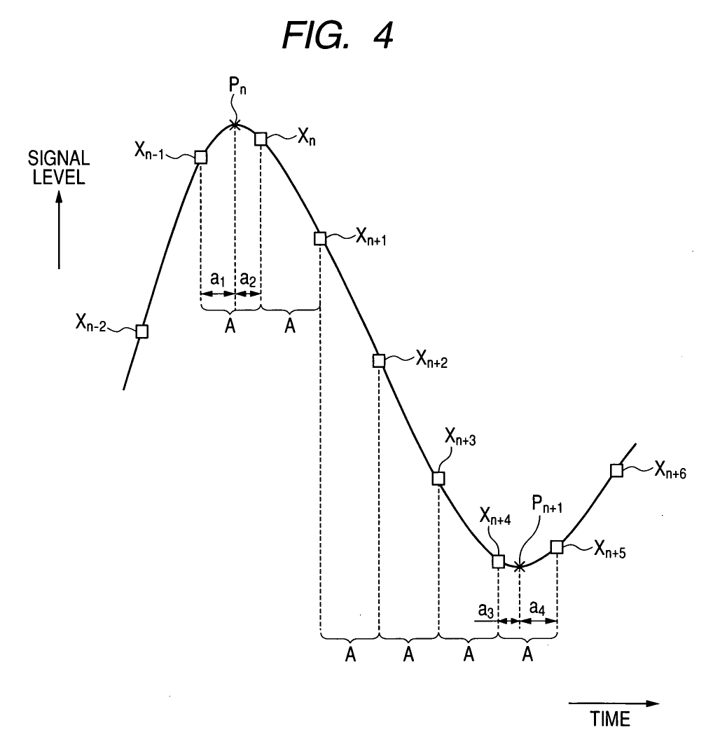

FIG. 3 is an enlarged view of a circular portion “I” in FIG. 2. In FIG. 3, “Xₙ” denotes a maximum-corresponding sample detected by the maximum detecting section 102, and “Pₙ” denotes an analog-waveform peak estimated by the peak-value interpolating section 104 through Lagrange-polynomial interpolation from the values of the peak-corresponding sample Xₙ, the pre-peak sample Xₙ₋₁, the second pre-peak sample Xₙ₋₂, the post-peak sample Xₙ₊₁, and the second post-peak sample Xₙ₊₂. With reference to FIG. 3, the time intervals between the samples are equal to the prescribed constant value “A” (the prescribed sampling period).

During the estimation of the analog-waveform peak Pₙ, the peak-value interpolating section 104 calculates the time interval “a₁” between the sample Xₙ₋₁ and the estimated peak Pₙ. The peak-value interpolating section 104 notifies the peak-position measuring section 105 of the calculated time interval “a₁”.

The peak-position measuring section 105 computes the time position “a₂” of the estimated peak Pₙ relative to the time position of the peak-corresponding sample Xₙ (that is, the time interval “a₂” between the estimated peak Pₙ and the peak-corresponding sample Xₙ) from the sampling period “A” and the time interval “a₁” according to the following equation.

a₂=A−a₁ (1)

Then, the peak-position measuring section 105 recognizes that the time position of the estimated peak Pₙ precedes the time position of the peak-corresponding sample Xₙ by the computed time interval “a₂”.

With reference to FIG. 4, a minimum-corresponding sample Xₙ₊₄ detected by the minimum detecting section 103 is a peak-corresponding sample immediately following the former peak-corresponding sample, that is, the maximum-corresponding sample Xₙ. In FIG. 4, “Pₙ₊₁” denotes an analog-waveform peak estimated by the peak-value interpolating section 104 through Lagrange-polynomial interpolation from the values of the peak-corresponding sample Xₙ₊₄, the pre-peak sample Xₙ₊₃, the second pre-peak sample Xₙ₊₂, the post-peak sample Xₙ₊₅, and the second post-peak sample Xₙ₊₆.

During the estimation of the analog-waveform peak Pₙ₊₁, the peak-value interpolating section 104 calculates the time interval “a₃” between the peak-corresponding sample Xₙ₊₄ and the estimated peak Pₙ₊₁. The peak-value interpolating section 104 notifies the peak-position measuring section 105 of the calculated time interval “a₃”.

The peak-position measuring section 105 labels the notified time interval “a₃” as the time position “a₃” of the estimated peak Pₙ₊₁ relative to the time position of the peak-corresponding sample Xₙ₊₄. Then, the peak-position measuring section 105 recognizes that the time position of the estimated peak Pₙ₊₁ follows the time position of the peak-corresponding sample Xₙ₊₄ by the time interval “a₃”.

The inter-peak interval measuring section 106 detects the time interval between the peak-corresponding samples Xₙ and Xₙ₊₄. The detected time interval is given as “4·A”, and is called the inter-peak-sample interval. On the other hand, the time interval between the estimated peaks Pₙ and Pₙ₊₁ is given as “a₂+4·A+a₃”, and is called the inter-estimated-peak interval. Accordingly, the time interval between the estimated peaks Pₙ and Pₙ₊₁ differs from that between the peak-corresponding samples Xₙ and Xₙ₊₄ by a value of “a₂+a₃”. The inter-peak interval measuring section 106 notifies the inter-peak-sample interval “4·A” to the adder 107. The peak-position measuring section 105 notifies the adder 107 of the time intervals “a₂” and “a₃”. The adder 107 adds the time intervals “a₂” and “a₃” to the inter-peak-sample interval “4·A”, thereby obtaining an inter-estimated-peak interval “a₂+4·A+a₃” equal to the time interval between the estimated peaks Pₙ and Pₙ₊₁. The adder 107 notifies the inter-estimated-peak interval “a₂+4·A+a₃” to the coefficient table selecting section 108. The adder 107 notifies the relative time positions “a₂” and “a₃” of the estimated peaks Pₙ and Pₙ₊₁ to the harmonic generating circuit 109.

The coefficient table selecting section 108 responds to the inter-estimated-peak interval “a₂+4·A+a₃”, and considers the above-indicated difference “a₂+a₃” in selecting one from the coefficients in the table. Specifically, the coefficient table selecting section 108 selects one from the coefficients in accordance with the inter-estimated-peak interval “a₂+4·A+a₃”. The coefficient table selecting section 108 notifies the harmonic generating circuit 109 of the selected coefficient. The harmonic generating circuit 109 uses the selected coefficient and the relative time positions “a₂” and “a₃” of the estimated peaks Pₙ and Pₙ₊₁ in shaping the waveform represented by the input digital audio signal to produce harmonics and add the produced harmonics to the waveform.

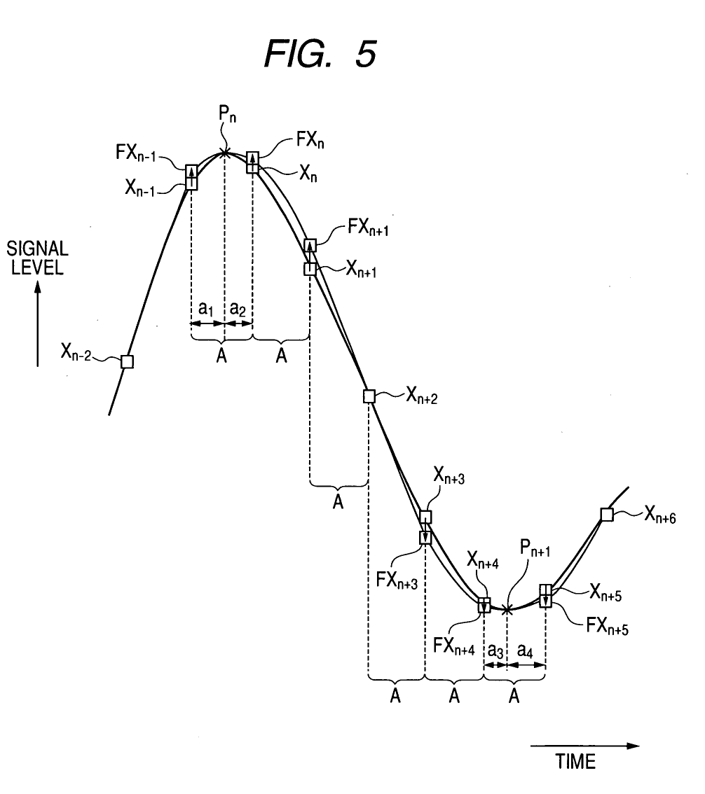

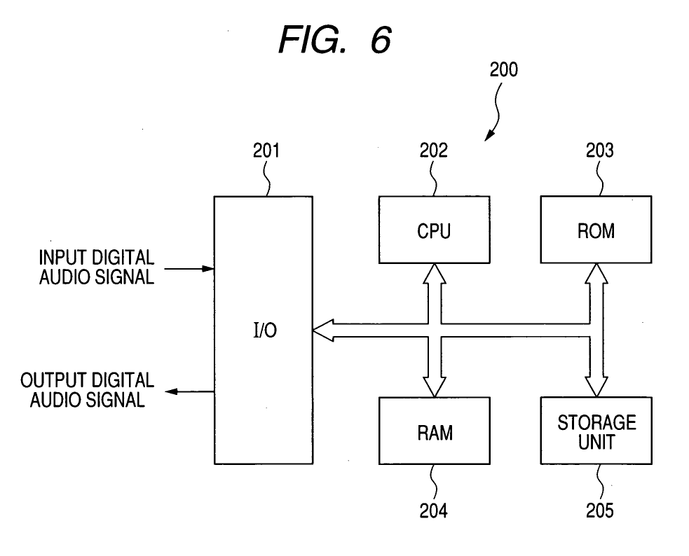

Operation of the apparatus 100 includes a sequence of steps which is executed each time the newest sample of the input digital audio signal is stored into the memory 101. The operation step sequence is as follows. The maximum detecting section 102 reads samples of the input digital audio signal from the memory 101. The maximum detecting section 102 refers to the read samples and thereby detects a local maximum in the waveform represented by the input digital audio signal, and a sample corresponding to the detected local maximum. In FIGS. 4 and 5, the maximum-corresponding sample detected by the maximum detecting section 102 is denoted by “Xₙ”. The minimum detecting section 103 reads samples of the input digital audio signal from the memory 101. The minimum detecting section 103 refers to the read samples and thereby detects a local minimum in the waveform represented by the input digital audio signal, and a sample corresponding to the detected local minimum. In FIGS. 4 and 5, the minimum-corresponding sample detected by the minimum detecting section 103 is denoted by “Xₙ₊₄”.

The peak-value interpolating section 104 responds to the detection of the maximum-corresponding sample Xₙ by the maximum detecting section 102 and the detection of the minimum-corresponding sample Xₙ₊₄ by the minimum detecting section 103.

The peak-value interpolating section 104 reads, from the memory 101, the maximum-corresponding sample Xₙ, the sample Xₙ₋₁ immediately preceding the maximum-corresponding sample Xₙ (the pre-maximum sample Xₙ₋₁), the sample Xₙ₋₂ second immediately preceding the maximum-corresponding sample Xₙ (the second pre-maximum sample Xₙ₋₂), the sample Xₙ₊₁ immediately following the maximum-corresponding sample Xₙ (the post-maximum sample Xₙ₊₁), and the sample Xₙ₊₂ second immediately following the maximum-corresponding sample Xₙ (the second post-maximum sample Xₙ₊₂). The peak-value interpolating section 104 estimates an ideal analog-waveform local maximum from the values of the maximum-corresponding sample Xₙ, the pre-maximum sample Xₙ₋₁, the second pre-maximum sample Xₙ₋₂, the post-maximum sample Xₙ₊₁, and the second post-maximum sample Xₙ₊₂ through Lagrange-polynomial interpolation. In FIGS. 4 and 5, the estimated local maximum is denoted by “Pₙ”. During the estimation of the analog-waveform maximum Pₙ, the peak-value interpolating section 104 calculates the time interval “a₁” between the sample Xₙ₋₁ and the estimated maximum Pₙ. The peak-value interpolating section 104 notifies the peak-position measuring section 105 of the calculated time interval “a₁”.

The peak-value interpolating section 104 reads, from the memory 101, the minimum-corresponding sample Xₙ₊₄, the sample Xₙ₊₃ immediately preceding the minimum-corresponding sample Xₙ₊₄ (the pre-minimum sample Xₙ₊₃), the sample Xₙ₊₂ second immediately preceding the minimum-corresponding sample Xₙ₊₄ (the second pre-minimum sample Xₙ₊₂), the sample Xₙ₊₅ immediately following the minimum-corresponding sample Xₙ₊₄ (the post-minimum sample Xₙ₊₅), and the sample Xₙ₊₆ second immediately following the minimum-corresponding sample Xₙ₊₄ (the second post-minimum sample Xₙ₊₆). The peak-value interpolating section 104 estimates an ideal analog-waveform local minimum from the values of the minimum-corresponding sample Xₙ₊₄, the pre-minimum sample Xₙ₊₃, the second pre-minimum sample Xₙ₊₂, the post-minimum sample Xₙ₊₅, and the second post-minimum sample Xₙ₊₆ through Lagrange-polynomial interpolation. In FIGS. 4 and 5, the estimated local minimum is denoted by “Pₙ₊₁”. During the estimation of the analog-waveform minimum Pₙ₊₁, the peak-value interpolating section 104 calculates the time interval “a₃” between the minimum-corresponding sample Xₙ₊₄ and the estimated minimum Pₙ₊₁. The peak-value interpolating section 104 notifies the peak-position measuring section 105 of the calculated time interval “a₃”.

The peak-position measuring section 105 computes the time position “a₂” of the estimated maximum Pₙ relative to the time position of the maximum-corresponding sample Xₙ (that is, the time interval “a₂” between the estimated maximum Pₙ and the maximum-corresponding sample Xₙ) from the sampling period “A” and the time interval “a₁” according to the previously-indicated equation (1). The peak-position measuring section 105 labels the notified time interval “a₃” as the time position of the estimated minimum Pₙ₊₁ relative to the time position of the minimum-corresponding sample Xₙ₊₄. The peak-position measuring section 105 feeds the adder 107 with signals representing the time position “a₂” of the estimated maximum Pₙ relative to the time position of the maximum-corresponding sample Xₙ and the time position of the estimated minimum Pₙ₊₁ relative to the time position of the minimum-corresponding sample Xₙ₊₄.

The inter-peak interval measuring section 106 responds to the detection of the maximum-corresponding sample Xₙ by the maximum detecting section 102 and the detection of the minimum-corresponding sample Xₙ₊₄ by the minimum detecting section 103. The inter-peak interval measuring section 106 measures the time interval (the inter-peak-sample interval) between the maximum-corresponding sample Xₙ and the minimum-corresponding sample Xₙ₊₄. In FIG. 4, the measured inter-peak-sample interval is “4·A”. The inter-peak interval measuring section 106 feeds a signal representative of the inter-peak-sample interval “4·A” to the adder 107.

The adder 107 adds the relative time positions “a₂” and “a₃” to the inter-peak-sample interval “4·A” to obtain an inter-estimated-peak interval “a₂+4·A+a₃” equal to the time interval between the estimated maximum Pₙ and the estimated minimum Pₙ₊₁. The adder 107 notifies the inter-estimated-peak interval “a₂+4·A+a₃” to the coefficient table selecting section 108. The adder 107 notifies the relative time positions “a₂” and “a₃” of the estimated peaks Pₙ and Pₙ₊₁ to the harmonic generating circuit 109.

The coefficient table selecting section 108 has a table of coefficients assigned to different inter-estimated-peak intervals. The coefficient table selecting section 105 selects, from the coefficients in the table, one assigned to an inter-estimated-peak interval equal to the notified inter-estimated-peak interval “a₂+4·A+a₃”. The coefficients in the table are predetermined so that the value of a sample temporally adjacent to a peak-corresponding sample will be less corrected in accordance with an increase in the inter-estimated-peak interval. The coefficient table selecting section 108 notifies the selected coefficient “C” to the harmonic generating circuit 109.

Information representing the estimated maximum Pₙ and the estimated minimum Pₙ₊₁ is sent from the peak-value interpolating section 104 to the harmonic generating circuit 109. Information about the detected maximum-corresponding sample Xₙ is sent from the maximum detecting section 102 to the harmonic generating circuit 109 via the peak-value interpolating section 104. Information about the detected minimum-corresponding sample Xₙ₊₄ is sent from the minimum detecting section 103 to the harmonic generating circuit 109 via the peak-value interpolating section 104.

The harmonic generating circuit 106 classifies samples of the input digital audio signal into groups including a first group and a second group. The first group has a prescribed number of successive samples centered at the maximum-corresponding sample Xₙ. According to predetermined equations, the harmonic generating circuit 106 calculates corrective values for the respective samples in the first group from the selected coefficient “C”, the time interval “a₂”, the value of the estimated maximum Pₙ, and the values of these samples. The second group has a prescribed number of successive samples centered at the minimum-corresponding sample Xₙ₊₄. According to predetermined equations, the harmonic generating circuit 106 calculates corrective values for the respective samples in the second group from the selected coefficient “C”, the time interval “a₃”, the value of the estimated minimum Pₙ₊₁, and the values of these samples.

For example, the first group has three successive samples, that is, the pre-maximum sample Xₙ₋₁, the maximum-corresponding sample Xₙ, and the post-maximum sample Xₙ₊₁. Similarly, the second group has three successive samples, that is, the pre-minimum sample Xₙ₊₃, the minimum-corresponding sample Xₙ₊₄, and the post-minimum sample Xₙ₊₅. In these cases, the harmonic generating circuit 106 calculates corrective values for the respective samples in the first and second groups as follows.

For the maximum-corresponding sample Xₙ which immediately follows the estimated maximum Pₙ, the harmonic generating circuit 106 computes the difference “Xₙ−Pₙ” in value between the maximum-corresponding sample Xₙ and the estimated maximum Pₙ. Then, the harmonic generating circuit 106 multiplies the computed difference “Xₙ−Pₙ” by the selected coefficient “C” to obtain a first multiplication result “(Xₙ−Pₙ)·C”. The selected coefficient “C” is decided by the interval between the estimated maximum Pₙ and the estimated minimum Pₙ₊₁. The harmonic generating circuit 106 multiplies the first multiplication result “(Xₙ−Pₙ)·C” by the time interval “a₂” to obtain a second multiplication result “(Xₙ−Pₙ)·C·a₂”. The harmonic generating circuit 106 labels the second multiplication result “(Xₙ−Pₙ)·C·a₂” as a corrective value VL1a for the maximum-corresponding sample Xₙ. In other words, the harmonic generating circuit 106 calculates a corrective value VL1a for the maximum-corresponding sample Xₙ according to the following equation.

VL1a=(Xₙ−Pₙ)·C·a₂ (2)

For the post-maximum sample Xₙ₊₁ which immediately follows the maximum-corresponding sample Xₙ, the harmonic generating circuit 106 computes the difference “Xₙ₊₁−Xₙ” in value between the samples Xₙ₊₁ and Xₙ. Then, the harmonic generating circuit 106 multiplies the computed difference “Xₙ₊₁−Xₙ” by the selected coefficient “C” to obtain a multiplication result “(Xₙ₊₁−Xₙ)·C”. The selected coefficient “C” is decided by the interval between the estimated maximum Pₙ and the estimated minimum Pₙ₊₁. The harmonic generating circuit 106 labels the multiplication result “(Xₙ₊₁−Xₙ)·C” as a corrective value VL1b for the post-maximum sample Xₙ₊₁. In other words, the harmonic generating circuit 106 calculates a corrective value VL1b for the post-maximum sample Xₙ₊₁ according to the following equation.

VL1b=(Xₙ₊₁−Xₙ)·C (3)

For the pre-maximum sample Xₙ₋₁ which immediately precedes the estimated maximum Pₙ, the harmonic generating circuit 106 computes the difference “Xₙ₋₁−Pₙ” in value between the pre-maximum sample Xₙ₋₁ and the estimated maximum Pₙ. Then, the harmonic generating circuit 106 calculates a corrective value VL1c for the pre-maximum sample Xₙ₋₁ according to the following equation.

VL1c=(Xₙ₋₁−Pₙ)·C·a₁ (4)

where “a₁” denotes the time interval equal to “A−a₂” (the sampling period “A” minus the time interval “a₂”), and “C” denotes the selected coefficient decided by the interval between the estimated maximum Pₙ and an estimated minimum Pₙ₋₁ immediately preceding the estimated maximum Pₙ.

For the minimum-corresponding sample Xₙ₊₄ which immediately precedes the estimated minimum Pₙ₊₁, the harmonic generating circuit 106 computes the difference “Xₙ₊₄−Pₙ₊₁” in value between the minimum-corresponding sample Xₙ₊₄ and the estimated minimum Pₙ₊₁. Then, the harmonic generating circuit 106 multiplies the computed difference “Xₙ₊₄−Pₙ₊₁” by the selected coefficient “C” to obtain a first multiplication result “(Xₙ₊₄−Pₙ₊₁)·C”. The selected coefficient “C” is decided by the interval between the estimated maximum Pₙ and the estimated minimum Pₙ₊₁. The harmonic generating circuit 106 multiplies the first multiplication result “(Xₙ₊₄−Pₙ₊₁)·C” by the time interval “a₃” to obtain a second multiplication result “(Xₙ₊₄−Pₙ₊₁)·C·a₃”. The harmonic generating circuit 106 labels the second multiplication result “(Xₙ₊₄−Pₙ₊₁)·C·a₃” as a corrective value VL2a for the minimum-corresponding sample Xₙ₊₄. In other words, the harmonic generating circuit 106 calculates a corrective value VL2a for the minimum-corresponding sample Xₙ₊₄ according to the following equation.

VL2a=(Xₙ₊₄−Pₙ₊₁)·C a₃ (5)

For the pre-minimum sample Xₙ₊₃ which immediately precedes the minimum-corresponding sample Xₙ₊₄, the harmonic generating circuit 106 computes the difference “Xₙ₊₃−Xₙ₊₄” in value between the samples Xₙ₊₃ and Xₙ₊₄. Then, the harmonic generating circuit 106 multiplies the computed difference “Xₙ₊₃−Xₙ₊₄” by the selected coefficient “C” to obtain a multiplication result “(Xₙ₊₃−Xₙ₊₄)·C”. The selected coefficient “C” is decided by the interval between the estimated maximum Pₙ and the estimated minimum Pₙ₊₁. The harmonic generating circuit 106 labels the multiplication result “(Xₙ₊₃−Xₙ₊₄)·C” as a corrective value VL2b for the pre-minimum sample Xₙ₊₃. In other words, the harmonic generating circuit 106 calculates a corrective value VL2b for the pre-minimum sample Xₙ₊₃ according to the following equation.

VL2b=(Xₙ₊₃−Xₙ₊₄)·C (6)

For the post-minimum sample Xₙ₊₅ which immediately follows the estimated minimum Pₙ₊₁, the harmonic generating circuit 106 computes the difference “Xₙ₊₅−Pₙ₊₁” in value between the post-minimum sample Xₙ₊₅ and the estimated minimum Pₙ₊₁. Then, the harmonic generating circuit 106 calculates a corrective value VL2c for the post-minimum sample Xₙ₊₅ according to the following equation.

VL2c=(Xₙ₊₅−Pₙ₊₁)·C·a₄ (7)

where “a₄” denotes the time interval equal to “A−a₃” (the sampling period “A” minus the time interval “a₃”), and “C” denotes the selected coefficient decided by the interval between the estimated minimum Pₙ₊₁ and an estimated maximum Pₙ₊₂ immediately following the estimated minimum Pₙ₊₁.

The samples Xₙ, Xₙ₊₁, Xₙ₊₃, and Xₙ₊₄ are located in the interval between the estimated maximum Pₙ and the next estimated minimum Pₙ₊₁. As indicated by the equation (2), the corrective value VL1a for the maximum-corresponding sample Xₙ is calculated from the difference in value between the present sample Xₙ and the estimated maximum Pₙ immediately preceding the present sample Xₙ, and the selected coefficient “C” decided by the interval between the estimated maximum Pₙ and the estimated minimum Pₙ₊₁. As indicated by the equation (3), the corrective value VL1b for the post-maximum sample Xₙ₊₁ is calculated from the difference in value between the present sample Xₙ₊₁ and the sample Xₙ immediately preceding the present sample Xₙ₊₁, and the selected coefficient “C” decided by the interval between the estimated maximum Pₙ and the estimated minimum Pₙ₊₁. As indicated by the equation (6), the corrective value VL2b for the pre-minimum sample Xₙ₊₃ is calculated from the difference in value between the present sample Xₙ₊₃ and the sample Xₙ₊₄ immediately following the present sample Xₙ₊₃, and the selected coefficient “C” decided by the interval between the estimated maximum Pₙ and the estimated minimum Pₙ₊₁. As indicated by the equation (5), the corrective value VL2a for the minimum-corresponding sample Xₙ₊₄ is calculated from the difference in value between the present sample Xₙ₊₄ and the estimated minimum Pₙ₊₁ immediately following the present sample Xₙ₊₄, and the selected coefficient “C” decided by the interval between the estimated maximum Pₙ and the estimated minimum Pₙ₊₁.

The pre-maximum sample Xₙ₋₁ is located in the interval between an estimated minimum Pₙ₋₁ and the next estimated maximum Pₙ. As indicated by the equation (4), the corrective value VL1c for the pre-maximum sample Xₙ₋₁ is calculated from the difference in value between the present sample Xₙ₋₁ and the estimated maximum Pₙ immediately following the present sample Xₙ₋₁, and the selected coefficient “C” decided by the interval between the estimated minimum Pₙ₋₁ and the estimated maximum Pₙ. The post-minimum sample Xₙ₊₅ is located in the interval between the estimated minimum Pₙ₊₁ and a next estimated maximum Pₙ₊₂. As indicated by the equation (7), the corrective value VL2c for the post-minimum sample Xₙ₊₅ is calculated from the difference in value between the present sample Xₙ₊₅ and the estimated minimum Pₙ₊₁ immediately preceding the present sample Xₙ₊₅, and the selected coefficient “C” decided by the interval between the estimated minimum Pₙ₊₁ and the estimated maximum Pₙ₊₂.

With reference to FIGS. 4 and 5, a sample Xₙ₋₂ immediately precedes the pre-maximum sample Xₙ₋₁. A sample Xₙ₊₆ immediately follows the post-minimum sample Xₙ₊₅. Corrective values for the samples Xₙ₋₂ and Xₙ₊₆ may be calculated similarly to the above-mentioned calculation of the corrective values VL1a, VL1b, VL1c, VL2a, VL2b, and VL2c for the samples Xₙ, Xₙ₊₁, Xₙ₋₁, Xₙ₊₄, Xₙ₊₃, and Xₙ₊₅. In this case, the calculation of the corrective value for the sample Xₙ₋₂ is based on computing the difference in value between the present sample Xₙ₋₂ and the immediately following sample Xₙ₋₁, and then multiplying the computed difference by the selected coefficient “C” for the interval between the estimated minimum Pₙ₋₁ and the estimated maximum Pₙ. The calculation of the corrective value for the sample Xₙ₊₆ is based on computing the difference in value between the present sample Xₙ₊₆ and the immediately preceding sample Xₙ₊₅, and then multiplying the computed difference by the selected coefficient “C” for the interval between the estimated minimum Pₙ₊₁ and the estimated maximum Pₙ₊₂.

The harmonic generating circuit 106 performs predetermined operations between the corrective values VL1c, VL1a, VL1b, VL2b, VL2a, and VL2c and the samples Xₙ₋₁, Xₙ, Xₙ₊₁, Xₙ₊₃, Xₙ₊₄, and Xₙ₊₅. The harmonic generating circuit 106 labels the operation results as new values for the samples Xₙ₋₁, Xₙ, Xₙ₊₁, Xₙ₊₃, Xₙ₊₄, and Xₙ₊₅. Then, the harmonic generating circuit 106 replaces the original values of the samples Xₙ₋₁, Xₙ, Xₙ₊₁, Xₙ₊₃, Xₙ₊₄, and Xₙ₊₅ with the new values, and thereby corrects these samples to have the new values. On the other hand, the harmonic generating circuit 106 keeps samples non-corrected which are relatively remote from maximum-corresponding and minimum-corresponding samples. The corrected samples and the non-corrected samples constitute the output digital audio signal.

For example, the harmonic generating circuit 106 subtracts the corrective values VL1c, VL1a, VL1b, VL2b, VL2a, and VL2c from the values of the samples Xₙ₋₁, Xₙ, Xₙ₊₁, Xₙ₊₃, Xₙ₊₄, and Xₙ₊₅ according to the following equations.

FXₙ₋₁=Xₙ₋₁VL1c (8)

FXₙ=Xₙ−VL1a (9)

FXₙ₊₁=Xₙ₊₁−VL1b (10)

FXₙ₊₃=Xₙ₊₃−VL2b (11)

FXₙ₊₄=Xₙ₊₄−VL2a (12)

FXₙ₊₅=Xₙ₊₅−VL2c (13)

The harmonic generating circuit 106 labels the subtraction results FXₙ₋₁, FXₙ, FXₙ₊₁, FXₙ₊₃, FXₙ₊₄, and FXₙ₊₅ as new values for the samples Xₙ₋₁, Xₙ, Xₙ₊₁, Xₙ₊₃, Xₙ₊₄, and Xₙ₊₅, respectively. Then, the harmonic generating circuit 106 replaces the original values of the samples Xₙ₋₁, Xₙ, Xₙ₊₁, Xₙ₊₃, Xₙ₊₄, and Xₙ₊₅ with the new values, and thereby corrects these samples to have the new values.

The correction of the samples Xₙ₋₁, Xₙ, Xₙ₊₁, Xₙ₊₃, Xₙ₊₄, and Xₙ₊₅ by the harmonic generating circuit 106 produces a digital signal representative of harmonics, and adds the digital harmonic signal to the input digital audio signal to generate the output digital audio signal. The new values FXₙ₋₁, FXₙ, and FXₙ₊₁ of the samples at and around the maximum-corresponding sample Xₙ are proper so that these samples can be prevented from undergoing an excessive waveform shaping process. Similarly, the new values FXₙ₊₃, FXₙ₊₄, and FXₙ₊₅ of the samples at and around the minimum-corresponding sample Xₙ₊₄ are proper so that these samples can be prevented from undergoing an excessive waveform shaping process. In FIG. 5, the new sample values FXₙ₋₁, FXₙ, and FXₙ₊₁ are greater than the corresponding original sample values respectively while the new sample values FXₙ₊₃, FXₙ₊₄, and FXₙ₊₅ are smaller than the corresponding original sample values respectively.

Through the above-mentioned correction of specified ones among samples of the input digital audio signal, the harmonic generating circuit 106 shapes the waveform represented by the input digital audio signal to generate a digital signal of harmonics having frequencies higher than the Nyquist frequency of the input digital audio signal, and add the digital harmonic signal to the input digital audio signal to generate the output digital audio signal.

As previously described, the apparatus 100 (see FIG. 1) receives a sequence of samples of the input digital audio signal. The apparatus 100 detects every peak in the waveform represented by the input digital audio signal, and a sample corresponding to the detected peak. For every detected peak, the apparatus 100 estimates an ideal analog waveform peak from the peak-corresponding sample and samples around the peak-corresponding sample. Then, the apparatus 100 shapes the waveform represented by the input digital audio signal in response to the value of the estimated peak and the time position thereof. The effect of the waveform shaping on the input digital audio signal is more uniform than that of a waveform shaping process responsive to a peak-corresponding sample only.

### Second Embodiment

FIG. 6 shows a digital audio signal processing apparatus 200 according to a second embodiment of this invention. The apparatus 200 is similar to the apparatus 100 (see FIG. 1) except for design changes mentioned hereafter.

The apparatus 200 includes a computer, a digital signal processor, or a similar device having a combination of an input/output port 201, a CPU 202, a ROM 203, a RAM 204, and a storage unit 205. The input/output port 201 receives an input digital audio signal. The apparatus 200 converts the input digital audio signal into an output digital audio signal through a waveform shaping process. Specifically, the apparatus 200 corrects specified ones among samples of the input digital audio signal while holding the other samples as they are. The corrected samples and the non-corrected samples constitute the output digital audio signal. The input/output port 201 feeds the output digital audio signal to an apparatus output terminal or an external device (not shown). The storage unit 205 includes, for example, a combination of a hard disk and a drive for the hard disk.

The apparatus 200 (or the CPU 202) operates in accordance with a computer program stored in the ROM 203, the RAM 204, or the storage unit 205. The computer program may be read from a recording medium before being sent to the RAM 204 or the storage unit 205 via the input/output port 201 and being written therein. Alternatively, the computer program may be downloaded into the RAM 204 or the storage unit 205 from a server via a network and the input/output port 201. The computer program contains a table of coefficients assigned to different inter-estimated-peak intervals.

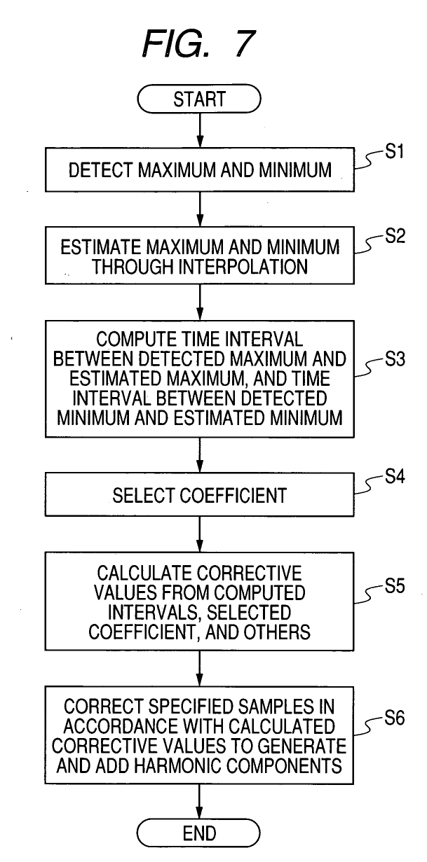

FIG. 7 is a flowchart of a segment of the computer program for the apparatus 200. The program segment in FIG. 7 is iteratively executed in synchronism with a sequence of samples of the input digital audio signal. Specifically, the program segment is executed for every sample of the input digital audio signal.

As shown in FIG. 7, a first step S1 of the program segment decides whether or not the third latest sample is a maximum-corresponding sample. When the third latest sample is a maximum-corresponding sample, the step S1 stores information about the maximum-corresponding sample into the RAM 204 for later use. The stored information represents the time position and the value of the maximum-corresponding sample. In addition, the step S1 decides whether or not the third latest sample is a minimum-corresponding sample. When the third latest sample is a minimum-corresponding sample, the step S1 stores information about the minimum-corresponding sample into the RAM 204 for later use. The stored information represents the time position and the value of the minimum-corresponding sample. Specifically, the step S1 reads the second, third, and fourth latest samples from the RAM 204. Then, the step S1 compares the values of the second, third, and fourth latest samples to implement the decisions about a maximum-corresponding sample and a minimum-corresponding sample (peak-corresponding samples). In more detail, the step S1 subtracts the value of the fourth latest sample from the value of the third latest sample to get a first subtraction result. The step S1 subtracts the value of the third latest sample from the value of the second latest sample to get a second subtraction result. The step S1 checks the signs of the first and second subtraction results. When the first subtraction result is positive and the second subtraction result is negative, the step S1 decides that the third latest sample is a maximum-corresponding sample. On the other hand, when the first subtraction result is negative and the second subtraction result is positive, the step S1 decides that the third latest sample is a minimum-corresponding sample. In the other cases, the step S1 decides that the third latest sample is neither a maximum-corresponding sample nor a minimum-corresponding sample. In FIGS. 4 and 5, the detected maximum-corresponding sample is denoted by “Xₙ”, and the detected minimum-corresponding sample is denoted by “Xₙ₊₄”. The step S1 stores the latest sample into the RAM 204 for later use. At the same time, the step S1 may erase the oldest sample from the RAM 204. Furthermore, the step S1 stores information about the time position of the latest sample into the RAM 204. The step S1 corresponds to the maximum detecting section 102 and the minimum detecting section 103 in FIG. 1.

When the step S1 decides that the third latest sample is a peak-corresponding sample (a maximum-corresponding sample or a minimum-corresponding sample), the program advances from the step S1 to a step S2. Otherwise, the program exits from the step S1 and then the current execution cycle of the program segment ends.

In the case where the step S1 decides that the third latest sample is a maximum-corresponding sample, the step S2 implements the following actions. The step S2 reads, from the RAM 204, the maximum-corresponding sample Xₙ, the pre-maximum sample Xₙ₋₁, the second pre-maximum sample Xₙ₋₂, the post-maximum sample Xₙ₊₁, and the second post-maximum sample Xₙ₊₂. The step S2 estimates an ideal analog-waveform local maximum from the values of these samples Xₙ, Xₙ₋₁, Xₙ₋₂, Xₙ₊₁, and Xₙ₊₂ through Lagrange-polynomial interpolation as the peak-value interpolating section 104 in FIG. 1 does. In FIGS. 4 and 5, the estimated local maximum is denoted by “Pₙ”. The step S2 calculates the time interval “a₁” between the sample Xₙ₋₁ and the estimated maximum Pₙ.

In the case where the step S1 decides that the third latest sample is a minimum-corresponding sample, the step S2 implements the following actions. The step S2 reads, from the RAM 204, the minimum-corresponding sample Xₙ₊₄, the pre-minimum sample Xₙ₊₃, the second pre-minimum sample Xₙ₊₂, the post-minimum sample Xₙ₊₅, and the second post-minimum sample Xₙ₊₆. The step S2 estimates an ideal analog-waveform local minimum from the values of these samples Xₙ₊₄, Xₙ₊₃, Xₙ₊₂, Xₙ₊₅, and Xₙ₊₆ through Lagrange-polynomial interpolation as the peak-value interpolating section 104 in FIG. 1 does. In FIGS. 4 and 5, the estimated local minimum is denoted by “Pₙ₊₁”. The step S2 calculates the time interval “a₃” between the minimum-corresponding sample Xₙ₊₄ and the estimated minimum Pₙ₊₁.

The step S2 corresponds to the peak-value interpolating section 104 in FIG. 1.

A step S3 following the step S2 computes the time interval “a₂” between the estimated maximum Pₙ and the maximum-corresponding sample Xₙ (that is, the time position “a₂” of the estimated maximum Pₙ relative to the time position of the maximum-corresponding sample Xₙ) from the sampling period “A” and the time interval “a₁” according to the previously-indicated equation (1). The step S3 labels the time interval “a₃” as the time position of the estimated minimum Pₙ₊₁ relative to the time position of the minimum-corresponding sample Xₙ₊₄. The step S3 corresponds to the peak-position measuring section 105 in FIG. 1.

A step S4 subsequent to the step S3 retrieves information about peak-corresponding samples from the RAM 204. By referring to the retrieved information, the step S4 measures the time interval (the inter-peak-sample interval) between the latest peak-corresponding sample and the second latest peak-corresponding sample, for example, the time interval between the maximum-corresponding sample Xₙ and the minimum-corresponding sample Xₙ₊₄. In FIG. 4, the measured inter-peak-sample interval is “4·A”. The step S4 adds the relative time positions “a₂” and “a₃” to the inter-peak-sample interval “4·A” to obtain an inter-estimated-peak interval “a₂+4·A+a₃” equal to the time interval between the estimated maximum Pₙ and the estimated minimum Pₙ₊₁. The step S4 selects, from the coefficients in the table, one assigned to the obtained inter-estimated-peak interval. The step S4 corresponds to the inter-peak interval measuring section 106, the adder 107, and the coefficient table selecting section 108.

Regarding the second latest peak-corresponding sample, a step S5 following the step S4 implements the following actions. In the case where the second latest peak-corresponding sample is the maximum corresponding sample Xₙ, the step S5 labels the samples Xₙ₋₁, Xₙ, and Xₙ₊₁ as specified ones to be corrected. The step S5 calculates the corrective values VL1a, VL1b, and VL1c for the specified samples Xₙ, Xₙ₊₁, and Xₙ₋₁ from the selected coefficients, the time interval “a₂”, the value of the estimated maximum Pₙ, and the values of these specified samples according to the previously-indicated equations (2)-(4). In the case where the second latest peak-corresponding sample is the minimum corresponding sample Xₙ₊₄, the step S5 labels the samples Xₙ₊₃, Xₙ₊₄, and Xₙ₊₅ as specified ones to be corrected. The step S5 calculates the corrective values VL2a, VL2b, and VL2c for the specified samples Xₙ₊₄, Xₙ₊₃, and Xₙ₊₅ from the selected coefficients, the time interval “a₃”, the value of the estimated minimum Pₙ₊₁, and the values of these specified samples according to the previously-indicated equations (5)-(7). The step S5 corresponds to the harmonic generating circuit 109 in FIG. 1.

In the case where the second latest peak-corresponding sample is the maximum corresponding sample Xₙ, a step S6 subsequent to the step S5 subtracts the corrective values VL1c, VL1a, and VL1b from the values of the specified samples Xₙ₋₁, Xₙ, and Xₙ₊₁ according to the previously-indicated equations (8)-(10). The step S6 labels the subtraction results as new values for the specified samples Xₙ₋₁, Xₙ, and Xₙ₊₁, respectively. Then, the step S6 replaces the original values of the specified samples Xₙ₋₁, Xₙ, and Xₙ₊₁ with the new values, and thereby corrects these specified samples to have the new values. In the case where the second latest peak-corresponding sample is the minimum corresponding sample Xₙ₊₄, the step S6 subtracts the corrective values VL2b, VL2a, and VL2c from the values of the specified samples Xₙ₊₃, Xₙ₊₄, and Xₙ₊₅ according to the previously-indicated equations (11)-(13). The step S6 labels the subtraction results as new values for the specified samples Xₙ₊₃, Xₙ₊₄, and Xₙ₊₅, respectively. Then, the step S6 replaces the original values of the specified samples Xₙ₊₃, Xₙ₊₄, and Xₙ₊₅ with the new values, and thereby corrects these specified samples to have the new values. On the other hand, the step S6 keeps unspecified samples non-corrected. The unspecified samples are relatively remote from peak-corresponding samples. The step S6 combines the corrected samples and the non-corrected samples into a portion of the output digital audio signal. Through the above-mentioned correction of specified ones among samples of the input digital audio signal, the step S6 shapes the waveform represented by the input digital audio signal to generate a digital signal of harmonics having frequencies higher than the Nyquist frequency of the input digital audio signal, and add the digital harmonic signal to the input digital audio signal to generate the output digital audio signal. After the step S6, the current execution cycle of the program segment ends. The step S6 corresponds to the harmonic generating circuit 109 in FIG. 1.

What is claimed is:

1. A method of processing a digital audio signal having a sequence of samples having values representative of a waveform, comprising the steps of:
comparing values of temporally adjacent samples to detect peak-corresponding samples which correspond to respective peaks including local maximums and local minimums in the waveform;
estimating an ideal waveform peak from the value of each detected peak-corresponding sample and values of samples temporally adjacent to said detected peak-corresponding sample through interpolation;
calculating a time interval between every two temporally adjacent estimated peaks;
selecting one from coefficients in accordance with the calculated time interval; and
correcting the value of each detected peak-corresponding sample and values of samples temporally adjacent to said detected peak-corresponding sample in response to the selected coefficient, the value of an estimated peak corresponding to said detected peak-corresponding sample, and a time position of said estimated peak.

2. A method as recited in claim 1, wherein the detected peak-corresponding samples are detected maximum-corresponding samples and detected minimum-corresponding samples, and the estimated peaks are estimated maximums and estimated minimums, and wherein the correcting step comprises:
making a first sample group having each detected maximum-corresponding sample and a prescribed number of samples temporally adjacent to said detected maximum-corresponding sample;
for each sample in the first sample group, calculating a first difference in value between said sample and a next sample or an estimated maximum corresponding to the first sample group, and multiplying the calculated first difference by the selected coefficient to obtain a first corrective value;
making a second sample group having each detected minimum-corresponding sample and a prescribed number of samples temporally adjacent to said detected minimum-corresponding sample;
for each sample in the second sample group, calculating a second difference in value between said sample and a next sample or an estimated minimum corresponding to the second sample group, and multiplying the calculated second difference by the selected coefficient to obtain a second corrective value;
changing the value of each sample in the first sample group in response to the first corrective value; and
changing the value of each sample in the second sample group in response to the second corrective value.

3. A method as recited in claim 2, wherein for a time interval from each estimated maximum to a next estimated minimum, the correcting step comprises:
calculating a difference in value between said estimated maximum and a post-estimated-maximum sample immediately following said estimated maximum and being in the first sample group;
measuring a time interval between said estimated maximum and said post-estimated-maximum sample;
multiplying said calculated difference, said measured time interval, and the selected coefficient to obtain a multiplication result;
labeling said obtained multiplication result as the first corrective value for said post-estimated-maximum sample;
calculating a difference in value between each of the samples in the first sample group except the post-estimated-maximum sample and a sample immediately preceding said each of the samples;
multiplying said calculated difference by the selected coefficient to obtain a multiplication result;
labeling said obtained multiplication result as the first corrective value for said each of the samples;
calculating a difference in value between said estimated minimum and a pre-estimated-minimum sample immediately preceding said estimated minimum and being in the second sample group;
measuring a time interval between said estimated minimum and said pre-estimated-minimum sample;
multiplying said calculated difference, said measured time interval, and the selected coefficient to obtain a multiplication result;
labeling said obtained multiplication result as the second corrective value for said pre-estimated-minimum sample;
calculating a difference in value between each of the samples in the second sample group except the pre-estimated-minimum sample and a sample immediately following said each of the samples;
multiplying said calculated difference by the selected coefficient to obtain a multiplication result; and
labeling said obtained multiplication result as the second corrective value for said each of the samples; and
wherein for a time interval from each estimated minimum to a next estimated maximum, the correcting step comprises:
calculating a difference in value between said estimated maximum and a pre-estimated-maximum sample immediately preceding said estimated maximum and being in the first sample group;
measuring a time interval between said estimated maximum and said pre-estimated-maximum sample;
multiplying said calculated difference, said measured time interval, and the selected coefficient to obtain a multiplication result;
labeling said obtained multiplication result as the first corrective value for said pre-estimated-maximum sample;
calculating a difference in value between each of the samples in the first sample group except the pre-estimated-maximum sample and a sample immediately following said each of the samples;
multiplying said calculated difference by the selected coefficient to obtain a multiplication result;
labeling said obtained multiplication result as the first corrective value for said each of the samples;
calculating a difference in value between said estimated minimum and a post-estimated-minimum sample immediately following said estimated minimum and being in the second sample group;
measuring a time interval between said estimated minimum and said post-estimated-minimum sample;
multiplying said calculated difference, said measured time interval, and the selected coefficient to obtain a multiplication result;
labeling said obtained multiplication result as the second corrective value for said post-estimated-minimum sample;
calculating a difference in value between each of the samples in the second sample group except the post-estimated-minimum sample and a sample immediately preceding said each of the samples;
multiplying said calculated difference by the selected coefficient to obtain a multiplication result; and
labeling said obtained multiplication result as the second corrective value for said each of the samples.

4. An apparatus for processing a digital audio signal having a sequence of samples having values representative of a waveform, comprising:
means for comparing values of temporally adjacent samples to detect peak-corresponding samples which correspond to respective peaks including local maximums and local minimums in the waveform;
means for estimating an ideal waveform peak from the value of each detected peak-corresponding sample and values of samples temporally adjacent to said detected peak-corresponding sample through interpolation;
means for calculating a time interval between every two temporally adjacent estimated peaks;
means for selecting one from coefficients in accordance with the calculated time interval; and
means for correcting the value of each detected peak-corresponding sample and values of samples temporally adjacent to said detected peak-corresponding sample in response to the selected coefficient, the value of an estimated peak corresponding to said detected peak-corresponding sample, and a time position of said estimated peak.

5. An apparatus as recited in claim 4, wherein the detected peak-corresponding samples are detected maximum-corresponding samples and detected minimum-corresponding samples, and the estimated peaks are estimated maximums and estimated minimums, and wherein the correcting means comprises:
means for making a first sample group having each detected maximum-corresponding sample and a prescribed number of samples temporally adjacent to said detected maximum-corresponding sample;
means for, for each sample in the first sample group, calculating a first difference in value between said sample and a next sample or an estimated maximum corresponding to the first sample group, and multiplying the calculated first difference by the selected coefficient to obtain a first corrective value;
means for making a second sample group having each detected minimum-corresponding sample and a prescribed number of samples temporally adjacent to said detected minimum-corresponding sample;
means for, for each sample in the second sample group, calculating a second difference in value between said sample and a next sample or an estimated minimum corresponding to the second sample group, and multiplying the calculated second difference by the selected coefficient to obtain a second corrective value;
means for changing the value of each sample in the first sample group in response to the first corrective value; and
means for changing the value of each sample in the second sample group in response to the second corrective value.

6. An apparatus as recited in claim 5, wherein for a time interval from each estimated maximum to a next estimated minimum, the correcting means comprises:
means for calculating a difference in value between said estimated maximum and a post-estimated-maximum sample immediately following said estimated maximum and being in the first sample group;
means for measuring a time interval between said estimated maximum and said post-estimated-maximum sample;
means for multiplying said calculated difference, said measured time interval, and the selected coefficient to obtain a multiplication result;
means for labeling said obtained multiplication result as the first corrective value for said post-estimated-maximum sample;
means for calculating a difference in value between each of the samples in the first sample group except the post-estimated-maximum sample and a sample immediately preceding said each of the samples;
means for multiplying said calculated difference by the selected coefficient to obtain a multiplication result;
means for labeling said obtained multiplication result as the first corrective value for said each of the samples;
means for calculating a difference in value between said estimated minimum and a pre-estimated-minimum sample immediately preceding said estimated minimum and being in the second sample group;
means for measuring a time interval between said estimated minimum and said pre-estimated-minimum sample;
means for multiplying said calculated difference, said measured time interval, and the selected coefficient to obtain a multiplication result;
means for labeling said obtained multiplication result as the second corrective value for said pre-estimated-minimum sample;
means for calculating a difference in value between each of the samples in the second sample group except the pre-estimated-minimum sample and a sample immediately following said each of the samples;
means for multiplying said calculated difference by the selected coefficient to obtain a multiplication result; and
means for labeling said obtained multiplication result as the second corrective value for said each of the samples; and
wherein for a time interval from each estimated minimum to a next estimated maximum, the correcting means comprises:
means for calculating a difference in value between said estimated maximum and a pre-estimated-maximum sample immediately preceding said estimated maximum and being in the first sample group;
means for measuring a time interval between said estimated maximum and said pre-estimated-maximum sample;
means for multiplying said calculated difference, said measured time interval, and the selected coefficient to obtain a multiplication result;
means for labeling said obtained multiplication result as the first corrective value for said pre-estimated-maximum sample;
means for calculating a difference in value between each of the samples in the first sample group except the pre-estimated-maximum sample and a sample immediately following said each of the samples;
means for multiplying said calculated difference by the selected coefficient to obtain a multiplication result;
means for labeling said obtained multiplication result as the first corrective value for said each of the samples;
means for calculating a difference in value between said estimated minimum and a post-estimated-minimum sample immediately following said estimated minimum and being in the second sample group;
means for measuring a time interval between said estimated minimum and said post-estimated-minimum sample;
means for multiplying said calculated difference, said measured time interval, and the selected coefficient to obtain a multiplication result;
means for labeling said obtained multiplication result as the second corrective value for said post-estimated-minimum sample;
means for calculating a difference in value between each of the samples in the second sample group except the post-estimated-minimum sample and a sample immediately preceding said each of the samples;
means for multiplying said calculated difference by the selected coefficient to obtain a multiplication result; and
means for labeling said obtained multiplication result as the second corrective value for said each of the samples.
